(19) United States
(12) Patent Application Publication
(10) Pub. No.: US 2007/0067999 A1
(43) Pub. Date: Mar. 29, 2007

(54) Stepped bushing for a pocket knife

(76) Inventors: Thomas Arrowsmith, Bradford, PA (US); Scott D. Freer, Cyclone, PA (US)

Correspondence Address: HODGSON RUSS LLP, ONE M & T PLAZA, SUITE 2000, BUFFALO, NY, 14203-2391, US

(21) Appl. No.: 11/526,348

(22) Filed: Sep. 25, 2006

Related U.S. Application Data
(60) Provisional application No. 60/721,198, filed on Sep. 28, 2005.

(51) Int. Cl. B26B 3/06

(52) U.S. Cl. 30/157

(57) ABSTRACT

A pocket knife comprising a handle with opposed first and second handle end portions, a first blade with an opening and first and second liners. Each of the first and second liners has a liner bushing opening. A stepped bushing having a first portion having a first outside surface, a second portion having a second outside surface and a third portion having a third outside surface is provided. The stepped bushing has a bushing opening. The second portion and third portion of the stepped bushing are positioned in liner bushing openings in the first and second liners to locate the stepped bushing in the pocket knife. The first blade is pivotally connected to the first portion such that the first blade can be pivoted on the first outside surface between open and closed positions. A pin extends through the bushing opening and the bushing opening has clearance such that the pin can be compressed during assembly of the pocket knife, and the pin is for holding the pocket knife together.

### CROSS REFERENCE TO RELATED APPLICATION

This application claims priority to U.S. Provisional Patent Application No. 60/721,198 filed Sep. 28, 2005, to Freer et al., entitled Stepped Bushing For Pocket Knife, the contents of which are hereby incorporated by reference.

### BACKGROUND

A pocket knife or folding knife has a handle having ends with a blade pivotally connected to an end of the handle. The pocket knife has a spring that biases the blade into the closed position so that knife can be safely handled. The handle has nickel silver bolsters at each end that are spot welded to liners, and a spring is positioned between the liners. The bolsters, liners, spring and tang of the blade have openings and nickel silver pins or nails are positioned in the openings. These nickel silver pins are cut to a predetermined length based on the stack height of the above-described components of the pocket knife. Subsequently, these components are put on an orbital forming machine that forms the nickel silver pin seamlessly into the nickel silver bolster openings on both sides of the knife.

A brass center pin is cut and a head is formed at both ends using a machine with opposed drill chucks holding spinner heads. The center pin extends through the pocket knife covers which can be, for example bone, plastic, and wood. The center pin also extends through the liners and spring and holds the center of the pocket knife together.

There can be, however, problems with respect to the structural configuration and method of assembly outlined above. For example, the material thickness dimension of the blade may vary to the high end of the manufactured tolerance, and the dimension of the spring may vary to the low end. Such a combination results in an undesirable tight blade condition making it difficult to pivot the blade between open and closed positions.

Another possible problem exists because the material thickness dimension of the blade may vary to the low end of the manufactured tolerance, and the dimension of the spring may vary to the high end. This combination results in an undesirable loose blade condition.

Another possible problem exists because the material thickness variation can also cause unsightly gaps at different areas in the pocket knife.

Another problem related to this assembly method occurs when the nickel silver pins and the brass center pin bend under the load of the head forming processes. This bending may cause disruption of the knife function at the end of the knife where the blade is located. In addition, when the pin bends it can change the position of the blade resulting in a blade misalignment and a blade that is difficult to pivot between the open and closed positions.

Thus, there is a need for an apparatus and method for manufacturing pocket knives that eliminates blade disruption.

### SUMMARY

The stepped bushing for a pocket knife invention advantageously eliminates blade disruption. The pocket knife has a handle with a first handle end portion and an opposed second handle end portion. A stepped bushing is provided that is installed in the first handle end portion of the pocket knife during assembly, and the stepped bushing has a first portion with a first outer surface, a second portion with a second outer surface and a third portion with a third outer surface. The first portion has a diameter greater than the diameters of the second and third portions. First and second blades having openings are pivotally connected to the first portion of the stepped bushing such that they can be pivoted on the first outer surface.

The handle has first and second liners, a center liner, first and second springs, a first pair of bolsters each having a first bolster opening for receiving a pin and a second pair of bolsters each having second bolster openings for receiving a pin. The first and second pairs of bolsters are joined to the first and second liners with, for example, a weld. There is also a center pin that extends through the middle portion of the pocket knife to hold the pocket knife together.

Each of the first and second liners has a liner bushing opening, a bushing side and an opposed handle side. The liner bushing opening in the first liner is sized to receive the second portion of the stepped bushing and the liner bushing opening in the second liner is sized to receive the third portion surface of the stepped bushing. The stepped bushing further comprises a first contact wall that contacts the bushing side of the first liner and a second contact wall that contacts the bushing side of the second liner. The second portion of the stepped bushing extends into the liner bushing opening in the first liner, and the third portion of the stepped bushing extends into the liner bushing opening in the second liner, such that the stepped bushing is located and positioned in the first handle end portion of the pocket knife by the first and second liners. This advantageously eliminates the need to locate the first and second blades in the pocket knife with the pin. In addition, the stepped bushing has a first end and a second end, and when the stepped bushing is positioned in the first and second liners as described above, there is a gap that extends from the first end of the bushing to the handle side of the first liner, and there is a gap that extends from the second end of the bushing to the handle side of the second liner. The gaps serve to prevent the stepped bushing from contacting the first pair of bolsters. A pin extends through an opening in the stepped bushing to hold the pocket knife together.

In another preferred embodiment, the pocket knife is made with just the first blade pivotally connected to the stepped bushing. In another embodiment the pocket knife has stepped bushings installed in both the first and second handle end portions ends of the handle to which blades are pivotally connected.

There is also a method of making a pocket knife with a stepped bushing. The method includes providing a handle having first and second liners and a first and second pair of bolsters. First and second blades with openings are provided, along with a first liner and a second liner each have a liner bushing opening. The method includes providing a stepped bushing with a bushing opening. The stepped bushing is provided with a first portion, a first bushing end and a second bushing end. The first and second blades are pivotally connected to the first portion of the stepped bushing. The method includes positioning the first bushing end in the liner bushing opening in the first liner, and positioning the second bushing end in the liner bushing opening in the second liner such that the stepped bushing locates the first and second blades in the pocket knife. An orbital forming machine is provided for forming heads on the pin for holding the pocket knife together.

### BRIEF DESCRIPTION OF THE DRAWING FIGURES

The stepped bushing for a folding knife invention is illustrated throughout the drawing figures. The same reference number is used to call out the same or similar surfaces, components, elements, structures or features.

FIG. 1 is a perspective view of a pocket knife wherein the blades are in the partly open position.

FIG. 2 is an exploded perspective view of the pocket knife.

FIG. 3 is an exploded right end elevational view of the first and second blades and first, second and center liners.

FIG. 4 is a sectional view of the pocket knife taken along cut lines 4-4 in FIG. 1.

FIG. 5 is a left perspective view of the stepped bushing.

FIG. 6 is a right end elevational view of the stepped bushing.

FIG. 7 is a front elevational view of the stepped bushing.

FIG. 8 is a sectional view of a second embodiment of the present invention.

### DETAILED DESCRIPTION

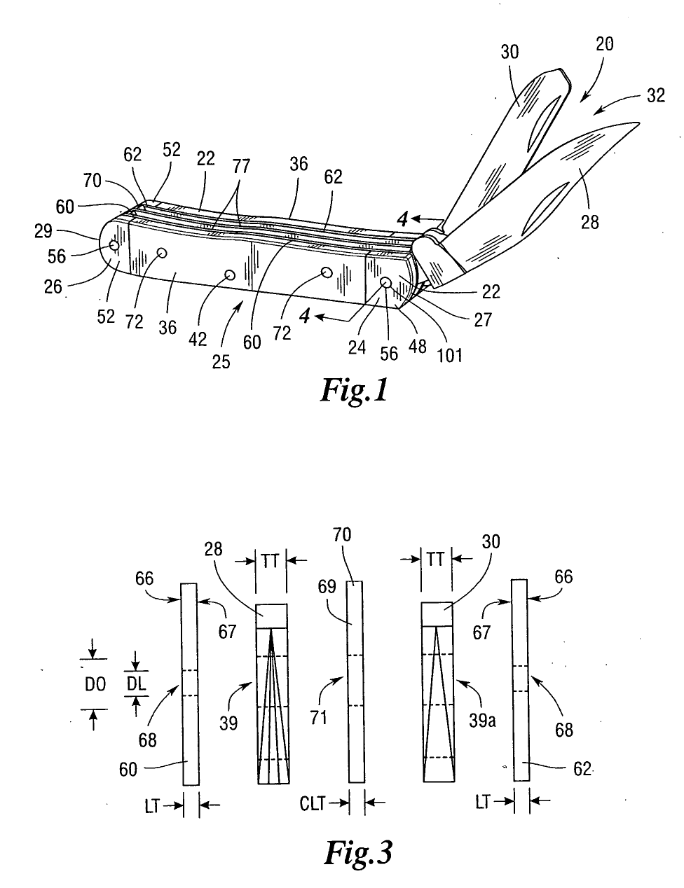

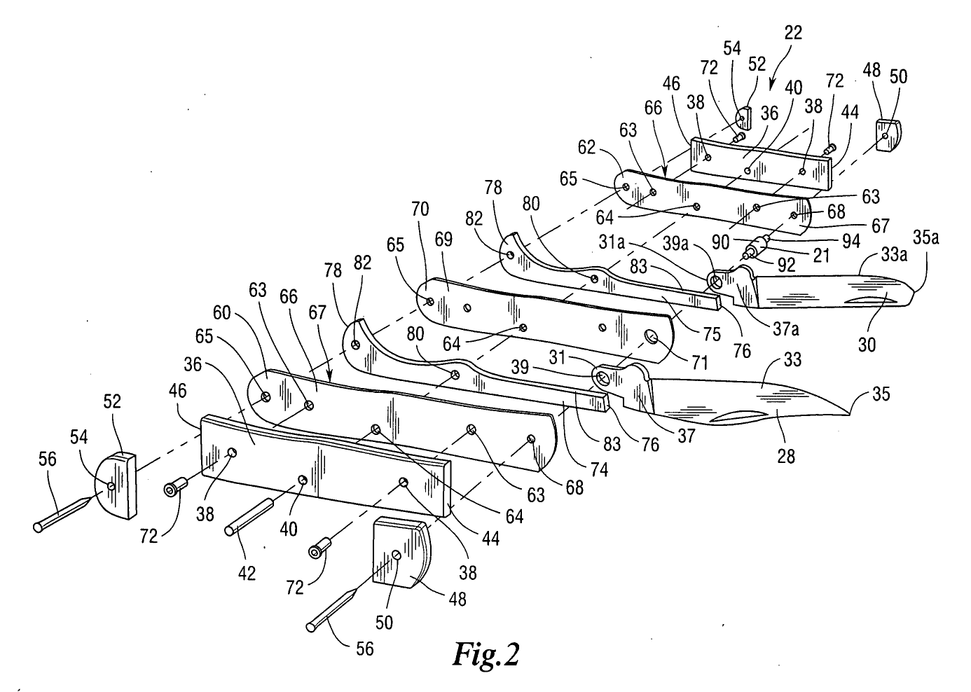

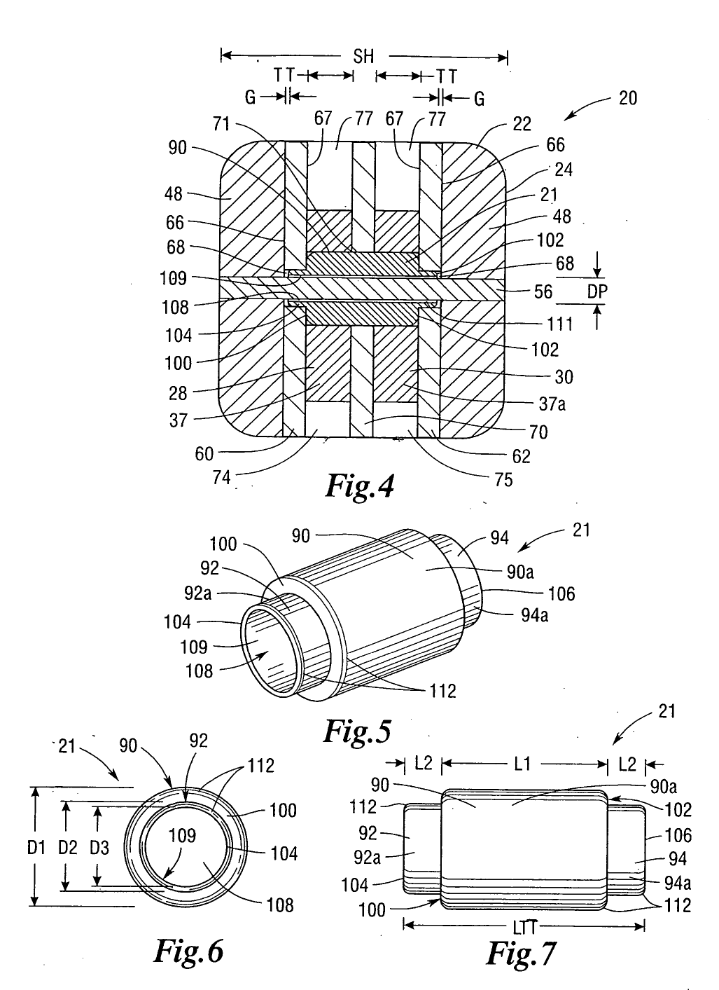

FIGS. 1-3 show a stepped bushing 21 for a pocket knife 20 embodying the present invention. The pocket knife or folding knife 20 has a handle 22 having a first end 27 and an opposed second end 29. As shown in FIG. 1, the handle 22 has a first handle end portion 24 at the first end 27 and a second handle end portion 26 at the second end 29. Positioned internal to the first handle end portion 24 of the pocket knife 20 is the stepped bushing 21 that pivotally connects first and second blades 28, 30, respectively, to the handle 22, such that they can be pivoted from a closed position (not shown) through a partly open position 32 as shown in FIG. 1, to a fully open position (not shown). As shown in the exploded view of FIG. 2, the handle 22 has first and second liners 60, 62, respectively with bushing openings 68, and as shown in FIG. 4, the stepped bushing 21 is positioned in the bushing openings 68, such that the first liner 60 and second liner 62 function to locate the stepped bushing 21 in the pocket knife 20.

Continuing with FIG. 2, the handle 22 has covers 36 each having rivet openings 38, a cover center pin opening 40 through which a center pin 42, preferably of brass, is positioned and opposed first and second cover ends 44, 46, respectively. A pair of first bolsters 48 having first bolster openings 50 and a pair of second bolsters 52 having second bolster openings 54 are provided, and the first and second bolster openings 50, 54 are for receiving pins, commonly designated 56, therein. The pins 56 are preferably nickel silver.

As shown in FIGS. 2 and 3, the first and second liners 60, 62, respectively, are the same shape and each has a handle side commonly designated 66 and a bushing side commonly designated 67, with liner rivet openings 63. There is also a center liner 70 with a center liner bushing opening 71 and having opposed side surfaces 69. Each of the first and second liners 60, 62, respectively, and center liner 70 also has a liner center pin opening commonly designated 64, and a pin opening commonly designated 65, as shown in FIG. 2. Each of the first and second liners 60, 62, respectively, has a liner bushing opening commonly designated 68 having a liner opening diameter designated DL in FIG. 3, and the center liner bushing opening 71 has a diameter designated DO in FIG. 3. The center liner bushing opening 71 and liner bushing openings 68 are sized to receive the stepped bushing 21 as will be described presently. In addition, as shown in FIG. 3, the first and second liners 60, 62, respectively, each has a liner thickness designated LT, and the center liner 70 has a center liner thickness designated CLT. In a preferred embodiment the liner thickness LT and the center liner thickness CLT are the same dimension, but could be different in other embodiments.

As shown in FIG. 2, the first bolster openings 50 of the first pair of bolsters 48 are aligned with the first and second liners 60, 62, respectively, such that the first bolster openings 50 and the liner bushing openings 68 are in line. The first pair of bolsters 48 are spot welded to the first and second liners 60, 62, respectively. In a similar manner, the second bolster openings 54 in the second pair of bolsters 52 are aligned with the first and second liners 60, 62, respectively, such that the second bolster openings 54 and the pin openings 65 are in line. The second pair of bolsters 52 are spot welded to the first and second liners 60, 62, respectively.

Cover rivets 72 are aligned with and introduced into the cover rivet openings 38 in the covers 36 and the first and second liners 60, 62, respectively, and riveted. This connects the covers 36 and the first liner 60 and the second liner 62. Connecting covers 36 to liners with rivets is well known to those having ordinary skill in the art.

As shown in FIG. 2, there are first and second springs 74, 75, respectively, having substantially the identical shape. Each of the first spring 74 and second spring 75 has a first spring end commonly designated 76 and a second spring end commonly designated 78, and each has a spring center pin opening commonly designated 80 and a spring pin opening commonly designated 82. The spring pin openings 82 are proximal the second spring ends 78. The first and second springs 74, 75, respectively, are positioned such that the spring nail openings 82 align with the second bolster openings 54, and align with the second liner openings 65 in the first and second liners 60, 62, respectively. As shown in FIG. 2, the spring center pin openings 80 align with the cover pin openings 40, the liner center pin openings 64 in the center liner 70 and the first and second liners 60, 62, respectively. As shown in FIGS. 2 and 4, the center liner 70 is disposed between the first blade 28 and the second blade 30, and between the first spring 74 and the second spring 75. As shown in FIGS. 1 and 4, blade recesses commonly designated 77 are defined by the first liner 60, first spring 74 and center liner 70, and by the second liner 62, second spring 75 and center liner 70. The blade recesses 77 for receiving the first and second blades 28, 30, respectively, when they are in the closed position (not shown).

The first spring ends 76 are disposed adjacent the first blade 28 and second blade 30. In particular and as shown in FIGS. 2-4, the first blade 28 has a blade 37 having a cam surface 31 and a tang thickness designated TT; an edge 33; a tip 35; and the tang 37 has a blade opening 39. The second blade 30 has a second blade tang 37a having a second cam surface 31a and a tang thickness designated TT; a second blade edge 33a; a second blade tip 35a; and the second blade tang 37a has a second blade opening 39a. The blade opening 39, second blade opening 39a and center liner bushing opening 71 have substantially the same diameters commonly designated DO as shown in FIG. 3. Each of the first spring ends 76 has a cam contact surface 83 over which the cam surfaces 31, 31a, of the first and second blades 28, 30, respectively, are rotated when they are pivoted. The first and second springs 74, 75, respectively are for driving the first and second blades 28, 30, respectively into the closed position.

As shown in FIGS. 2 and 4-7, the stepped bushing 21 includes a first portion 90 having a first outside surface 90a, a second portion 92 having a second outside surface 92a, and a third portion having 94 having a third outside surface 94a. The second and third portions 92, 94, respectively, are disposed on opposite sides of the first portion 90. As shown in FIG. 6, the first portion 90 has a first diameter designated D1, the second portion 92 has a second diameter designated D2, and the third portion 94 has a third diameter designated D2, and D2 is less than D1. The first portion 90 also has a length, designated L1 in FIG. 7, and the second and third portions 92, 94, respectively, each have a length commonly designated L2 in FIG. 7. Thus, the stepped bushing 21 has the general shape of a stepped cylinder and has a total length, designated LTT in FIG. 7 which is the sum of L1i plus L2 plus L2. It is to be understood that the total length dimension designated LTT of the stepped bushing 21 can be infinitely varied (increased or decreased) in other embodiments depending on the number of tangs, liners and springs, and the thicknesses of the tangs, liners and springs.

The stepped bushing 21 has a first contact wall 100 that extends from the first outside surface 90a to the second outside surface 92a, and an opposed second contact wall 102 that extends from the first outside surface 90a to the third outside surface 94a. The stepped bushing 21 has first bushing end 104 and an opposed second bushing end 106, with a bushing opening 108 extending from the first bushing end 104 to the second bushing end 106. As shown FIG. 6, the bushing opening 108 has an interior bushing diameter designated D3, which is of greater dimension than a diameter designated DP in FIG. 4 of the pin 56, such that the pin 56 can be introduced in the bushing opening 108 during the assembly process as will be described presently. In addition, as shown in FIGS. 5 and 6, an internal bushing surface 109 surrounds the bushing opening 108. There are a chamfered edges, commonly designated 112, where the first bushing end 104 and the second outside surface 92a meet, the first contact wall 100 and the first outside surface 90a meet, the first outside surface 90a and the second contact wall 102 meet and the third outside surface 94a and the second bushing end 106 meet.

As shown in FIGS. 4 and 6, the diameter designated D1 of the first surface 90 is less than the diameter of the blade openings 39, 39a, and center liner bushing opening 71, commonly designated DO in FIG. 3. This allows the stepped bushing 21 to be positioned in the blade openings 39, 39a and center liner bushing opening 71 as shown in FIG. 4. In addition, as shown in FIG. 4, the first bushing contact wall 100 of the stepped bushing 21 abuts against the bushing side 67 of the first liner 60, and the second contact wall 102 of the stepped bushing 21 abuts against the bushing side 67 of the second liner 62. The first blade 28 and second blade 30 can be advantageously pivoted between the open position 32 and closed position on the outside surface 90a of the first portion 90 of the stepped bushing 21. In addition, the first and second blades 28, 30, respectively are not loose or misaligned when pivotally connected to the stepped bushing 21 in the manner shown in FIG. 4.

As shown in FIGS. 2 and 4, during assembly, the stepped bushing 21 is moved through the opening 39 in the tang 37 of the first blade 28, through the center liner bushing opening 71, and through the opening 39a in the tang 37a of the second blade 30. In addition, the length designated L2 of the second portion 92 of the stepped bushing 21 is less than the liner thickness designated LT of the first liner 60, and the length designated L2 of the third portion 94 of the stepped bushing 21 is less than the liner thickness designated LT of the second liner 62. Thus, as shown in FIG. 4, in one of the preferred embodiments the second portion 92 of the stepped bushing 21 is positioned in the liner bushing opening 68 in the first liner 60 without extending beyond the handle side 66 of the first liner 60, and the third portion 94 of the stepped bushing 21 is positioned in the liner bushing opening 68 in the second liner 62 without extending beyond the handle side 66 of the second liner 62. This advantageously eliminates contact between the stepped bushing 21 and the first pair of bolsters 48. As shown, in FIG. 4, there is there is a gap or space commonly designated G that extends from the first bushing end 104 to the handle side 66 of the first liner 60, and there is a gap designated G that extends from the second bushing end 106 to the handle side 66 of the second liner 62. Thus, in the above-described manner the stepped bushing 21 is installed in the first handle end portion 24 of the pocket knife 20. In another embodiment (not shown) the first and second ends 104, 106, respectively of the stepped bushing 21 are flush with the handle sides 66 of the first liner 60 and the second liner 62. As shown in FIGS. 2 and 4, the pin 56 extends through the openings 50 first pair of bolsters 48 and the bushing opening 108.

During assembly compressive forces are applied to the pins 56 and they bend and deform. In particular, as shown in FIG. 2 and described above, one of the pins 56 is inserted through one of the first bolster openings 50, the opening 108 in the stepped bushing 21 and the other first bolster opening 50. A pin 56 is also inserted through the second bolster opening 54 in one of the second bolsters 52, the liner pin opening 65 in the first liner 60, the spring pin opening 82 in the first spring 74, the liner nail opening 65 in the center liner 70, the spring nail opening 82 in the second spring 75, the liner nail opening 65 in the second liner 62 and the second bolster opening 54 in the other second bolster 52. The pins 56 are cut to proper length based on the stack height or thickness designated SH in FIG. 4 of the above described components. The pin 56 is has a pin diameter designated DP in FIG. 4 that is less than the diameter of the bushing opening designated D3 in FIG. 6, which provides for extra clearance for the pin 56. Thus, there is a space 111 that extends from the pin 56 to the interior bushing surface 109 when the pin 56 is positioned in the stepped bushing 21, shown in FIG. 4.

Subsequently, the pocket knife 20 is placed on an orbital forming machine (not shown) that forms the nickel silver pin 56 seamlessly into the first bolster openings 50 in the first pair of bolsters 48, and the second bolster openings 54 in the pair of second bolsters 52. The pins 56 compress and bend in the orbital forming machine. The above-described space 111 provides for room for the pin 56 to bend and deform during compression, while at the same time the first and second blades 28, 30, respectively, remain in position during the assembly process, that is, they remain aligned and their location does not change. Orbital forming machines are well known to those having ordinary skill in the art. The compression and deformation of pins during the manufacture of pocket knives is well known to those having ordinary skill in the art.

In addition, as shown in FIG. 2 during assembly the center pin 42 is inserted through the center pin opening 40 in one of the covers 36, the liner center pin opening 64 in the first liner 60, spring center pin opening 80 of the first spring 74, liner center pin opening 64 in the center liner 70, spring center pin opening 80 in the second spring 75, the liner center pin opening 64 in the second liner 62, and center pin opening 40 in the other cover 36. The center pin 42 is cut to length and has a head formed at both ends using a machine with opposing drill chucks holding spinner heads (not shown). Machines with opposed drill chucks for holding spinner heads are well known to those having ordinary skill in the art. As shown in FIG. 1, the center pin 42 holds a center or middle portion 25 of the pocket knife 20 together.

The stepped bushing 21 advantageously absorbs the compressive forces associated with the above described assembly of the pocket knife 20, such these forces have little or no affect on the tang 37 of the first blade 28 and the tang 37a of the second blade 30. In particular, any compressive forces applied to the first pair of bolsters 48 during assembly are transmitted through the first and second liners 60, 62, respectively, and to the first and second contact walls 100, 102, respectively, of the stepped bushing 21, and not the tangs 37, 37a, respectively of the first and second blades 28, 30, respectively. In addition, the stepped bushing 21 location advantageously does not change during assembly, because the stepped bushing 21 is located and supported by the first and second liners 60, 62, respectively, as described above, and not a pin 56. Thus, the stepped bushing 21 is not affected by misalignment of the first bolster openings 50 that can occur when the first bolsters 48 are spot welded to the first and second liners 60, 62, respectively. The stepped bushing 21 advantageously has a fixed first outer surface 90a about which the first and second blades 28, 30, respectively, can freely pivot between open and closed positions. Pivoting the blade of a pocket knife between open and closed positions is well known to those having ordinary skill in the art. As another advantage, the stepped bushing 21 provides ample clearance for the pin 56 to pass through the bushing opening 108, such that in the event the first pair of bolsters 48 is off location it does not affect the position of the first and second blades 28, 30, respectively.

The stepped bushing 21 advantageously provides a more stable blade pivot as compared to the use of a nickel silver pin 56 as a pivot. The alignment of the first and second blade 28, 30, respectively, is now controlled by the liner bushing openings 68 which are not affected by the bending of the pin 56 during assembly. The length dimension designated LI of the first portion 90 in FIG. 4 can be controlled to provide the spacing needed for all components described above that the stepped bushing 21 passes through, while at the same time allowing freedom for the first and second blades 28, 30, respectively, to rotate and the center liner 70 to float.

In addition, the use of the stepped bushing 21 advantageously eliminates tight and loose blade conditions of the first and second blades 28, 30, respectively. This is because alignment and location of the first and second blades 28, 30, respectively, is controlled by the second portion 92 of the stepped bushing 21 that is positioned in the liner bushing opening 68 in the first liner 60, and the third portion 94 of the stepped bushing that is positioned in the liner bushing opening 68 in the second liner 62.

The stepped bushing 21 invention advantageously provides concentric alignment of the first and second liners 60, 62, respectively, and the first and second blades 28, 30, respectively, while providing the positive stop spacing for the first and second blades 28, 30, respectively. The extra clearance in the bushing opening 108 allows maximum crush pressure on the nickel silver pin 56, advantageously eliminating a separation between the formed pin head periphery 101 (FIG. 1) and the first bolster openings 50. This undesirable separation is known as “pin show” and pin show is well known to those having ordinary skill in the art. In addition, because the stepped bushing 21 advantageously eliminates the need for the pin 56 to serve as the pivot for the first blade 28 and the second blade 30, the pivot 56 can serve to properly hold the pocket knife 20 together.

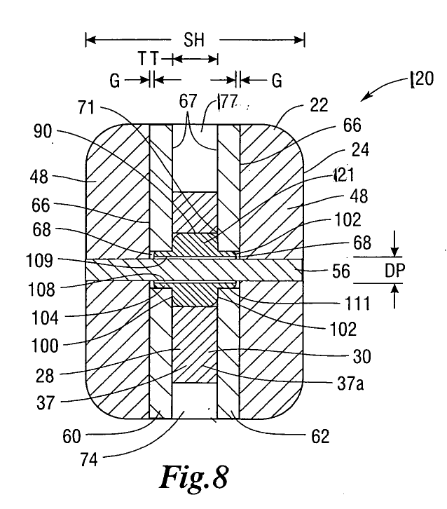

FIG. 8 shows sectional view (similar to that of FIG. 4) of a second embodiment. In this embodiment the stepped bushing 121 is installed in a pocket knife 120 having just the first blade 28. This embodiment differs from the first embodiment in that there is no center liner 70, no second blade 30 and no second spring 75, and differs in that the tang 37 of the first blade 28 and the first spring 74 extend from the first liner 60 to the second liner 62. This embodiment also differs from the first embodiment in that a blade recess 177 is defined by the first liner 60, second liner 62 and first spring 74. As shown in FIG. 8, the stepped bushing 121 extends from the first liner 60 to the second liner 62 and is supported in each in the same manner as described above in connection with the first embodiment, and the first blade 28 is pivotally connected to the stepped bushing 121 in the manner described above in connection with the first embodiment.

In another preferred embodiment (not shown) the pocket knife can be made with a stepped bushing 21 installed in the first handle end portion 24 of the pocket knife 20 as described above, and with a stepped bushing 21 installed in the second handle end portion 26 of the pocket knife in the same manner as described above. Such a configuration would be used in a pocket knife with blades pivotally connected to the stepped bushing 21 at the first and second handle end portions 24, 26, respectively.

It will be appreciated by those skilled in the art that while a stepped bushing for a pocket knife invention has been described above in connection with particular embodiments and examples, the invention is not necessarily so limited, and other embodiments, examples, uses, and modifications and departures from the described embodiments, examples, and uses may be made without departing from the stepped bushing for a pocket knife of this invention. All of these embodiments are intended to be within the scope and spirit of the present stepped bushing for a pocket knife invention.

What is claimed is:

1. A pocket knife comprising:
a) a handle having a first handle end portion and an opposed second handle end portion and having a stepped bushing positioned in the first handle end portion,
b) a first blade with an opening, and
c) wherein the stepped bushing is positioned in the blade opening such that the first blade is pivotally connected to the stepped bushing.

2. The pocket knife according to claim 1 wherein the stepped bushing has a first portion, a second portion and a third portion and the first blade is pivotally connected to the first portion.

3. The pocket knife according to claim 2 wherein the first portion has a first diameter and first outer surface and the second portion has a second diameter and second outer surface and the third portion has a third diameter and third outer surface and the first diameter is greater than the second and third diameters.

4. The pocket knife according to claim 2 further comprising a first liner and a second liner each having a liner bushing opening and wherein the liner bushing opening in the first liner is sized to receive the second portion of the stepped bushing and the liner bushing opening in the second liner is sized to receive the third portion of the stepped bushing.

5. The pocket knife according to claim 4 wherein the stepped bushing further comprises opposed first and second contact walls and each of the first liner and the second liner has opposed handle and bushing sides and wherein the first contact wall contacts the bushing side of the first liner and the second contact wall contacts the bushing side of the second liner such that assembly forces applied during assembly of the pocket knife are absorbed by the stepped bushing.

6. The pocket knife according to claim 4 wherein the second portion of the stepped bushing extends into the liner bushing opening in the first liner and the third portion of the stepped bushing extends into the liner bushing opening the second liner such that the stepped bushing is located in the pocket knife by the first liner and the second liner and the first portion of the stepped bushing aligns the first blade.

7. The pocket knife according to claim 3 wherein each of the first and second liners has a handle side and a bushing side and a liner bushing opening and the stepped bushing has a first bushing end and a second bushing end and a bushing opening, and the first bushing end is positioned in the liner bushing opening in the first liner such that there is a gap that extends from the first bushing end to the handle side of the first liner, and the second bushing end is positioned in the liner bushing opening in the second liner such that there is a gap that extends from the second bushing end to the handle side of the second liner.

8. The pocket knife according to claim 7 further comprising a first pair of bolsters each having a first bolster opening and one of the bolsters joined to the first liner and the other bolster joined to the second liner such that the first bolster openings align with the bushing opening and the gaps for preventing the stepped bushing from contacting the first pair of bolsters.

9. The pocket knife according to claim 8 wherein the stepped bushing has a bushing opening with an interior bushing diameter and a pin having a pin diameter that is less than the interior bushing diameter and the pin positioned in the first bolster openings and the bushing opening such that the pin can compress internal to the stepped bushing during assembly of the pocket knife and the pin for holding the pocket knife together.

10. The pocket knife according to claim 2 further comprising a second blade having an opening and a center liner positioned between the first blade and the second blade and the second blade is pivotally connected to the third portion of the stepped bushing.

11. A pocket knife comprising:
a) a handle,
b) a first blade having an opening,
c) a first liner and a second liner each having a liner bushing opening,
d) a stepped bushing comprising a first bushing end that is positioned in the liner bushing opening in the first liner and a second bushing end that is positioned in the liner bushing opening in the second liner and wherein the stepped bushing is positioned in the opening in the first blade to pivotally connect the first blade and the stepped bushing, and
e) wherein alignment of the first blade is controlled by the first liner and the second liner.

12. The pocket knife according to claim 11 further wherein the stepped bushing has a first portion having a first outside surface about which the first blade pivots, a second portion having a second outside surface that is positioned in the liner bushing opening in the first liner, and a third portion having a third outside surface that is positioned in the liner opening in the second liner.

13. The pocket knife according to claim 12 further wherein the stepped bushing has a stepped bushing opening and internal bushing surface and a pin is positioned in the stepped bushing opening and there is clearance between the pin and the internal bushing surface and the clearance for allowing the pin to compress internal to the stepped bushing.

14. The pocket knife according to claim 12 further comprising a second blade having an opening pivotally connected to the first portion of the stepped bushing such that the first blade can be pivoted on the first outside surface.

15. A method of making a pocket knife comprising:
providing a first blade having an opening,
providing a first liner and a second liner each having a liner bushing opening,
providing a stepped bushing with a first bushing end and a second bushing end and positioning the first bushing end in the liner bushing opening in the first liner and positioning the second bushing end in the liner bushing opening in the second liner and providing the stepped bushing with a first portion having a first outside surface, a second portion having a second outside surface and a third portion having a third outside surface, and
pivotally connecting the first blade to the first portion such that alignment of the first blade is controlled by the liner bushing openings in the first and second liners and the first blade can pivot on the first outside surface.

16. The method according to claim 15 further comprising providing a pin and providing the stepped bushing with a bushing opening and an internal bushing surface and positioning the pin in the bushing opening and providing clearance between the pin and internal bushing surface and the clearance for allowing the pin to bend during assembly of the pocket knife.

17. The method according to claim 15 further comprising providing a second blade and pivotally connecting the second blade to the first portion such that alignment of the second blade is controlled by the liner bushing openings in the first and second liners.
